(19) United States
(12) Patent Application Publication
(10) Pub. No.: US 2020/0293962 A1
(43) Pub. Date: Sep. 17, 2020

(54) RISK SCORING OF SUPPLIERS AND TRIGGERING PROCUREMENT WORKFLOW IN RESPONSE THERETO

(71) Applicant: Ivalua, Inc., Redwood City, CA (US)

(72) Inventors: Maud HERMAN, Belmont, CA (US); Nicolas LIEVAIN, Belmont, CA (US)

(21) Appl. No.: 16/818,868

(22) Filed: Mar. 13, 2020

Related U.S. Application Data
(60) Provisional application No. 62/819,481, filed on Mar. 15, 2019.

(51) Int. Cl. G06Q 10/06; G06F 16/25

(52) U.S. Cl. CPC G06Q 10/0635; G06F 16/254; G06Q 10/06315

(57) ABSTRACT

System and method for generating a supplier risk score in a procurement system. The method comprises storing source data pertaining to one or more suppliers in a relational database of the procurement system and aggregating portions of the source data by selected variables to determine risk values. The risk values are stored at locations within a multidimensional database having dimension member pairs corresponding to the selected variables. A supplier risk score is calculated responsive to a real-time sourcing request by leveraging the pre-aggregated risk values of the multidimensional database. A customized procurement workflow is triggered based on the calculated supplier risk score.

### CROSS-REFERENCE TO RELATED APPLICATIONS

This application claims the benefit of U.S. Provisional Application No. 62/819,481, filed Mar. 15, 2019, under 35 U.S.C. § 119(a). The above-referenced patent application is incorporated by reference in its entirety.

### BACKGROUND OF THE INVENTION

In a typical procurement and strategic sourcing system, suppliers are evaluated in terms of supply risk by computing an aggregate score that integrates data from a plurality of data sources and combines them to evaluate multiple risk criteria. These risk criteria include for instance operational risks, geopolitical risks, and legal risks.

The data sources typically include external data such as product offerings from online catalogues, or third-party data available on a subscription-basis, such as industry news from analysts or supplier credit scores from credit rating agencies. A risk score is typically derived by applying a mathematical function to aggregate the risk criteria into a single numerical value. The risk criteria can be used in making strategic sourcing decisions, such as adding or replacing a supplier, which are then performed by the organization.

There are multiple limitations in these traditional systems. First, the supply risk score is computed in a system that is not used on a daily basis by the users making operational decisions. Therefore, it takes time once a supply risk has been calculated to implement mitigation plans, as it takes time to propagate executive management decisions down to an operational level. Second, the risk score only integrates a limited set of internal data. Due to technical limitations in existing systems, there is only a limited set of internal data that can be used in the calculation of a supply risk score. Third, as the data used to compute a risk score comes from heterogeneous data sources, there are steps of data extraction, transformation and loading (“ETL”) to allow the integration of said data in a database. Because of the amount of voluminous data required for processing from internal and external sources, this step of ETL requires precious processing time. As such, the ETL does not allow for the integration of real-time data into the operational decision-making modules of the traditional procurement system.

As such, there is a need for an e-procurement system and method that addresses the above problems.

### SUMMARY

In one embodiment, a system and method for generating a supplier risk score in a procurement system. The method comprises storing source data pertaining to one or more suppliers in a relational database of the procurement system according to a plurality of variables; aggregating portions of the source data by selected ones of the plurality of variables to determine risk values, wherein the aggregating occurs at defined time intervals or responsive to an update of the source data stored in the relational database; storing the risk values at locations within one or more multidimensional databases having dimension member pairs corresponding to the selected ones of the plurality of variables; calculating a risk score of the one or more suppliers responsive to at least one of querying the source data stored in the relational database or the risk values stored in the one or more multidimensional databases; and triggering a procurement workflow based on the calculated risk score of the one or more suppliers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a schematic illustration of a procurement system, according to one illustrated embodiment.

FIG. 2 is a schematic illustration of a relational database and multidimensional database, according to one illustrated embodiment.

FIG. 3 is a block diagram illustration of various aspects of a supplier risk score broken down by risk elements, according to one illustrated embodiment.

FIG. 4 is a workflow rendering of the configuration module, according to one illustrated embodiment.

FIG. 5 is a screenshot mockup of a supplier risk scoreboard of the procurement system, according one illustrated embodiment.

### DETAILED DESCRIPTION OF CERTAIN INVENTIVE EMBODIMENTS

In the following detailed description, reference is made to the accompanying drawings, which form a part hereof. In the drawings, similar symbols or same reference numbers typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various examples of embodiments of the invention will now be described. The following description provides specific details for a thorough understanding and enabling description of these examples. One skilled in the relevant art will understand, however, that embodiments of the invention may be practiced without many of these details. Likewise, one skilled in the relevant art will also understand that embodiments incorporate many other obvious features not described in detail herein. Additionally, some well-known structures or functions may not be shown or described in detail below, so as to avoid unnecessarily obscuring the relevant description.

The terminology used herein is to be interpreted in its broadest reasonable manner, even though it is being used in conjunction with a detailed description of certain specific examples of the invention. Indeed, certain terms may even be emphasized below; any terminology intended to be interpreted in any restricted manner will, however, be overtly and specifically defined as such in this Detailed Description section.

The figures along with the following discussion provide a brief, general description of a suitable environment in which embodiments of the invention can be implemented. Although not required, aspects of various embodiments are described below in the general context of computer-executable instructions, such as routines executed by a general purpose data processing module, e.g., a networked server computer, cloud server, mobile device, tablet, or personal computer. Those skilled in the relevant art will appreciate that embodiments can be practiced with other communications, data processing, or computer system configurations, including: Internet appliances, hand-held devices (including smart phones, tablets, notebooks, wearable computers, all manner of corded, landline, fixed line, cordless, cellular or mobile phones, smart phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While embodiments of the invention, such as certain functions, may be described as being performed on a single device, embodiments of the invention can also be practiced in distributed environments where functions or modules are shared among disparate processing devices, which are linked through a communications network, such as, for example, a Local Area Network (LAN), Wide Area Network (WAN), the Internet, Bluetooth, and Zigbee. In a distributed computing environment, program modules may be located in both local and remote memory storage devices.

Embodiments of the invention may be stored or distributed on tangible computer-readable media, including magnetically or optically readable computer discs, cloud servers, hard-wired or preprogrammed chips (e.g., EEPROM semiconductor chips), nanotechnology memory, biological memory, or other data storage media. Alternatively or additionally, computer implemented instructions, data structures, screen displays, and other data under aspects of embodiments of the invention may be distributed over the Internet and via cloud computing networks or on any analog or digital network (packet switched, circuit switched, or other scheme).

The computer readable medium stores computer data, which data may include computer program code that is executable by a computer, in machine readable form. By way of example, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Embodiments of the invention are described herein with reference to operational illustration of modules, engines, widgets, or the like having functional blocks to illustrate methods employed by the procurement system to aggregate operational data on a rolling basis to incorporate a voluminous amount of operational data into real-time supplier risk score calculations. It will be understood that each of the modules, blocks, engines, widgets, and combinations thereof may be implemented by analog or digital hardware and computer program instructions. The computer program instructions may be provided to a processor of a general purpose computer, special purpose computer, application-specific integrated circuit (ASIC), or other programmable data processing apparatus such that the instructions, which execute via the processor of the computer or other programmable data processing apparatus, implements the functions/acts specified in the functional blocks of the flowcharts and/or the operational modules.

In some embodiments, the methods illustrated by the functional blocks may occur out of the order noted in the operational illustration of the modules, engines, and/or widgets. For example, two blocks shown in succession may be executed substantially concurrently. Alternatively and/or additionally, the blocks may be executed in reverse order.

A module is a software, hardware, or firmware (or combination thereof) system, process or functionality, or component thereof, that performs or facilitates the processes, features, and/or functions described herein. A module may include sub-modules or engines. Software components of a module may be stored on a computer readable medium. Modules may be integral to one or more servers, or be loaded and executed by one or more servers. One or more modules may be grouped into an application.

There is a need for a global supplier risk score card that: (i) can be used by multiple people with different roles in an organization (e.g., risk manager, sourcing managers, contract managers); and (ii) can leverage data from multiple data sources (e.g., internal operational data, forms, third party data) to provide an operator of an e-procurement system with updated supplier risk data at time of purchase order (PO) or requisition order (RO) without substantial delay. A challenge in current enterprise systems is the lack of consistency of risk scores from multiple risk data providers. In order to have consistency, some BI (business intelligence) dashboards can be developed. However, these dashboards are using out-of-date data and are not available to all the various roles in an organization. In order to solve these challenges, and without the need to develop custom software, Ivalua developed an innovative solution as described herein.

The embodiments disclosed herein allow for various personas within an organization to have access to up-to-date supplier risk score for various suppliers in the supply chain. The supplier risk score may incorporate both internal and external data from sources such as, for example, questionnaire campaigns, third party data sources, internal KPIs (Key Performance Indicator), and mixed sources. In particular, the disclosed embodiments identify risk elements (e.g., strategic, security, compliance, geographic, financial, quality, contractual, etc.) based, at least in part, on aggregating the internal and external data by dimensions. The aggregating of the internal/external data by dimensions may occur at defined times (e.g., hourly, daily, weekly). Having the aggregated internal/external data being updated on a rolling basis allows for the scoring system to incorporate a voluminous amount of internal/external data into real-time risk score calculations. Depending on the frequency of the aggregation, the real-time risk score calculations may substantially incorporate up-to-date data or pseudo real-time data.

The aggregated data by dimensions may be leveraged in the risk score calculations for the plurality of risk elements, where the risk elements make up the global supplier risk score. As such, responsive to an operator's initiation of risk score determination, the already pre-aggregated data may be used for real-time risk score calculation. As will be explained below, various instances of triggering the risk score calculation are contemplated by this disclosure. Additionally, as will be further explained below, the risk score calculation of one or more of the suppliers may be leveraged by the procurement system to automatically trigger a procurement workflow and/or workflow mitigation plan.

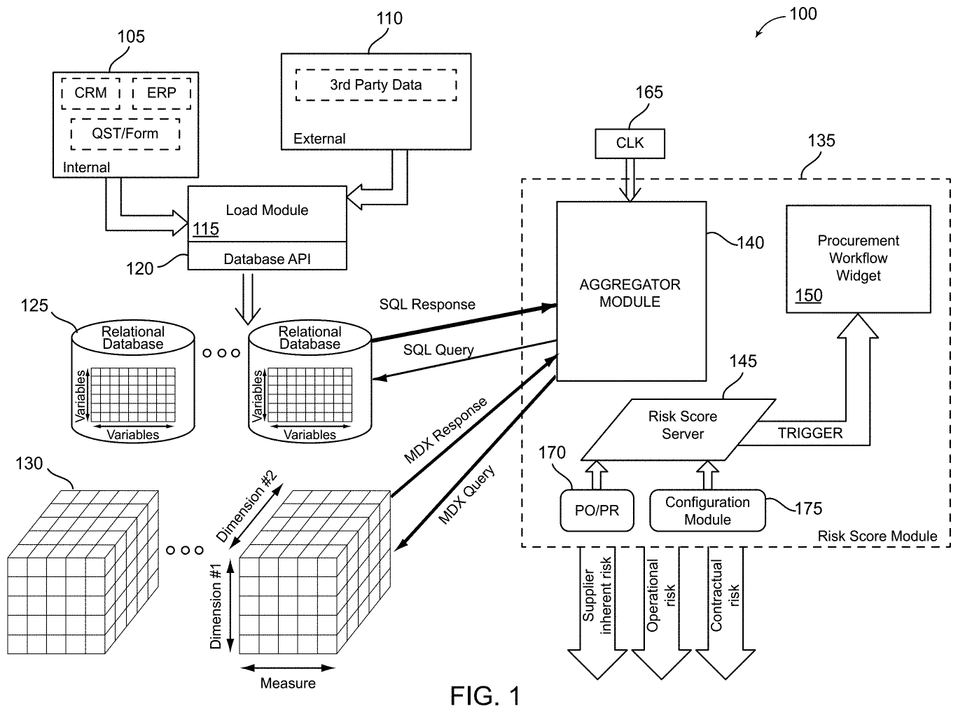

FIG. 1 shows a schematic illustration of a procurement system 100 according to one illustrated embodiment. The procurement system 100 comprises an internal data source 105, an external data source 110, a load module 115 communicatively coupled to the internal and external data sources 105, 110, a database API interface 120, a plurality of relational databases 125, a plurality of multidimensional databases 130, and a risk score module 135.

The risk score module 135 comprises an aggregator module 140 configured to implement aggregation of source data stored in the relational databases 125, a risk score server 145 configured to extract risk values from the multidimensional databases 130 and/or relevant portions of the source data from the relational databases 125 to calculate a supplier risk score, and a procurement workflow widget 150 to adjust automated procurement workflow through the supply chain based on the supplier risk score.

The internal data source 105 may take the form of any proprietary data of relevance to an enterprise (i.e., “buyer” in a procurement system) that can be retrieved from several of the buyer-side systems, such as, for example, ERP systems, SCM systems, CRM systems, supply databases, and/or inventories. These systems may exist across multiple business units of the enterprise. The internal data source 105 may provide proprietary information regarding internal operations, supply chain operations, internal resource planning, and customer relations. Some examples of source data stemming from the internal data source 105 may include: accounting systems, purchasing records, inventories/ledgers, inventory logs, production schedules, transportation schedules, warehouse locations, supplier ratings, purchase orders, work orders, Bill of Materials data, address directories, customer preferences, and site information, to name a few. It will be appreciated by those of ordinary skill in the art that these are just a sampling of types of source data from the internal data source 105 and various other types of data are contemplated by this disclosure. Additionally and/or alternatively, the source data from the internal source data 105 may stem from the buyer's response(s) to a questionnaire assessment (QST/Form). For example, the supplier ratings of the internal source data 105 may be responsive to buyers' responses to the questionnaire assessment. The questionnaire assessment may be electronically available such that input responses are leveraged by the risk score module 135 in real-time.

The external data source 110 may comprise external data originating outside the enterprise (outside the buyer-side organization). The external data may include any information that is of general interest to the buyer-side enterprise that may be relevant to determining a level of risk associated with the buyer's procurement request. The external data may originate from various third party sources such as, for example, product databases, electronic catalogs, online marketplaces, subscription sources, news sources, or the like. Some examples of external data may include: product name, product description, part number, compatible parts, price data, availability, fulfillment lead time, market reports, news bulletins, credit ratings, geographic security warnings, weather reports, political reports, import/export delays, corporate compliance risk, supplier ratings, and the like. It will be appreciated by those of ordinary skill in the art that these are just a sampling of types of external source data contemplated by this disclosure. Additionally, the internal and external source data 105, 110 may take the form of any data format.

The load module 115 may be configured to manage the process of loading and updating the relational databases 125. The source data may be loaded from the internal and external data sources 105, 110 at different times and in different formats. The load module 115 may organize the internal/external data so that the data is suitable for complex querying and analysis. The internal/external data may be encoded in any suitable format for representing structured or semi-structured data, such as, for example, flat files (CSV), spreadsheets, etc. Specifically, the load module 115 may function to extract the internal and external source data 105, 110 by invoking, for example, the necessary scripts. In some embodiments, the loading process may trigger the aggregator module 140 to implement aggregation of the source data (e.g., operational data) stored in the relational databases 125, as will be described herein. The term “source data” may refer to the internal/external data extracted from the internal and external data sources 105, 110 and loaded or stored in the relational databases 125.

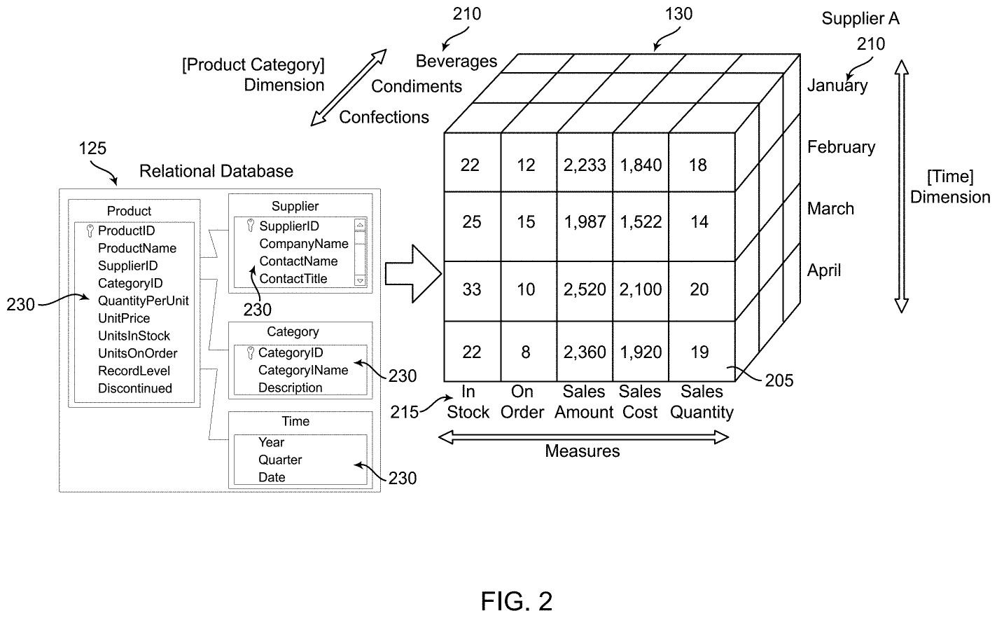

The database API interface 120 may be coupled to the load module 115. The database API interface 120 communicates with the relational databases 125 and in some embodiments may communicate with the multidimensional databases 130. The load module 115 may generate code in a database language (e.g., SQL, MDX), which calls the database API interface 120 in order to perform the task of loading. Loading from the internal and external data sources 110, 115 may be implemented in batch, single sequence, serial, parallel, and in any combination thereof. The load module 115 may perform incremental loading of internal/external data in parallel. For example, incremental loading may be implemented when existing data are modified or when new data are added. As will be discussed herein, various components of the risk score module 135 may communicate queries to the relational databases 125 and/or the multidimensional databases 130 via the database API interface 120. For example, the risk score module 135 may transmit SQL queries to extract source data from the relational databases 125, and may transmit MDX (Multidimensional expression) queries to extract risk values (FIG. 2) stored in the multidimensional databases 130.

The plurality of relational databases 125 may take the form of OLTP (Online Transaction Processing) databases where the source data is stored in two-dimensional database tables. As will be appreciated, OLTP is a category of data processing that is focused on transaction-oriented tasks. OLTP typically involves inserting, updating, and/or deleting small amounts of data in a database. OLTP transactions are usually specific in the task that they perform, and they usually involve a single data item or a small selection of data items. For example, a purchase order may entail transmitting a product from the supplier to the buyer. Such scenario involves a mere transfer from a first entity to a second entity and recording the product transfer. This is in contrast to Online Analytical Processing (OLAP), which usually involves querying many data items in a database for analytical purposes. An OLAP procurement example may be a buyer performing a query across all suppliers that offer a product category, so that the buyer can determine those suppliers which had the most on-time product deliveries during a particular time period. OLAP may be used to provide analytics on data that was captured via an OLTP application.

The plurality of multidimensional databases 130 may take the form of OLAP Cube databases (FIG. 2). The OLAP Cube is a method of storing data in a multidimensional form. In the OLAP Cubes, data items are categorized by dimensions, which comprise dimension members. The OLAP Cubes may be summarized across dimensions to improve query time over the relational databases. Typically, OLAP Cubes are used for advanced analytics such that a voluminous number of data items can be accessed rapidly.

As mentioned above, the risk score module 135 may comprise the aggregator module 140, the risk score server 145, and the procurement workflow widget 150. The aggregator module 140 may be communicatively coupled to the internal and external data sources 105, 110 via the load module 115. The aggregator module 140 is configured to run an aggregation on the source data of the relational databases 125 by select variables 230. The variables 230 selected from the relational databases 125, from which source data is extracted for aggregation, is determined based on the ultimate dimension member 210 pair the aggregation will be stored under in the multidimensional database 130. The aggregation is a method of summarizing a group of source data or data items by dimension member 210 in order to return a single value (hereinafter referred to as a “risk value” 205) for a particular pair of dimension members 210. As illustrated in FIG. 2, multidimensional databases 130 may comprise a plurality of dimension members (e.g., Confections, Condiments, Beverages) 210 within a Dimension (e.g., Product Category). Said differently, dimension members 210 from different dimensions in an OLAP Cube database for a particular measure 215. The value summary may be referred to herein as the risk value 205. In the FIG. 2 example illustration, the risk value 205 for the “Sales Quantity” measure calculated by the aggregator module 140 is stored at the intersection of the “Confections” and “April” dimension members. The risk value 205 of “19” reflects the extraction of quantity of “Confections” sales by Supplier A throughout “April.”

It will be understood that the relational database 125 may comprise an array of two-dimensional tables from which the aggregator module 140 is extracting the source data. The two-dimensional table arrays may comprise a time variable (e.g., year, quarter, date) and a product category variable (e.g., ProductID, ProductName, CategoryID), among other variables 230. The aggregator module 140 operates to run an aggregation algorithm across all two-dimensional tables of the relational databases 125 by a particular time variable (dates that indicate an April time stamp) and product variable (ProductID that indicates “Confections” product type) that is associated with the ultimate dimension member pair (e.g., Confections×April). For example, the aggregation may sum all data items of Supplier A sales of “Confections” products at each entry within “April” that is stored in the multiple tables of the relational databases 125. Upon completion of the summation, the total quantity of sales (e.g., 19) may be stored within the appropriate Cube (“Supplier A”) of the multidimensional databases 130 at the cross-section of the Confections×April dimension members 210.

It will be appreciated to those of ordinary skill in the art, that aggregation of data entries across the plurality of two-dimensional tables of the relational databases 125 may amount to significant processing time as a voluminous amount of source data is aggregated. As such, the aggregator module 140 may be triggered by a clock component 165 at defined intervals of time. The clock component 165 may be programmable to trigger the aggregator module 140 to run the aggregation on the source data of the relational databases 125 by predefined sets of variables 230. For example, the aggregation may occur hourly, weekly, bi-weekly, monthly, etc. The variables 230 may be predefined based on the stored dimension members 210 of the multidimensional databases 130. Upon completion of a programmed aggregation, the multidimensional databases 130 may be updated with revised risk values 205 by dimension member pairs 210 throughout the cubes. As such, the stored risk values 205 of the multidimensional databases 130 may be quickly retrieved without substantial processing time and delay.

Alternatively and/or additionally, the aggregator module 140 may be configured to run the aggregation on the source data of the relational databases 125 responsive to a trigger from the load module 115. The trigger may indicate that new or revised source data has been stored in the relational databases 125. In one embodiment, responsive to the update trigger, the aggregator module 140 initiates the aggregation (described above) and then proceeds to store the updated risk values 205 in the multidimensional databases 130. It is advantageous to have the risk values 205 updated on a defined rolling basis (either via update trigger or clock trigger) such that the risk values 205 of the multidimensional database 130, which are ultimately leveraged to calculate the supplier risk score, are substantially up-to-date. As will be discussed herein, although the source data stored in the relational database 125 may be updated in real-time, having to wait for completion of the aggregation process before calculating supplier risk scores would be prohibitive to the buyer-side operator interested in making supply chain decisions in real-time. As such, the disclosure contemplates performing the aggregation process prior to the buyer-side operator (who makes the real-time procurement decisions) initiating a supplier risk score request via the risk score module 135.

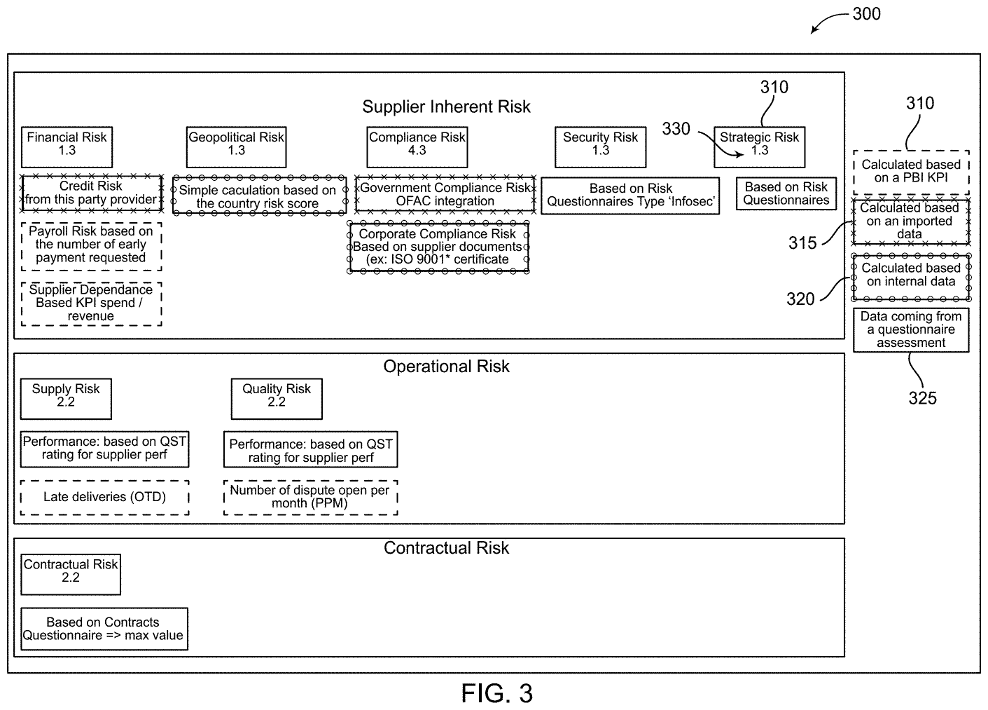

The risk score server 145 may be configured to transmit data queries to the multidimensional databases 130 and/or the relational databases 125. The data queries to the multidimensional databases 130 may take the form of MDX (Multidimensional Expression) queries or the like, while data queries to the relational databases 125 may take the form of SQL queries or the like. In some embodiments, the risk score server 145 may query the relational and/or multidimensional databases 125, 130 via the database API interface 120. Ultimately, the risk score server 145 transmits the queries to extract the risk values 205 from the multidimensional databases 130 and/or relevant portions of the source data from the relational databases 125 to calculate a supplier risk score. The supplier risk score (described in detail below) comprises particular combinations of the risk values 205. The combinations of the risk values 205 may include various mathematical and/or statistical calculations to determine one or more KPIs (Key Performance Indicators). As will be described herein, the KPIs are leveraged by the risk score module 135 to calculate the supplier risk score, including underlying risk element scores (FIG. 3).

The risk score server 145 may be triggered to query respective multidimensional databases 130 and/or relational databases 125 responsive to a sourcing request 170 (e.g., purchase order (PO), purchase requisition (PR)) and/or a buyer's direct supplier risk score inquiry. Once triggered, the risk score server 145 may expeditiously calculate the supplier risk score by leveraging the risk values 205 that have been pre-aggregated and stored in the multidimensional databases 130. Leveraging the pre-aggregated risk values 205 of the multidimensional databases 130 allows for the buyer to obtain the supplier risk score in substantially real-time. Additionally, it may be advantageous to trigger the aggregation process of the aggregator module 140 at more frequent time intervals to maintain up-to-date source data and thus up-to-date risk values 205 leveraged by the risk score server 145. Embodiments of the disclosure contemplate the strategic balance of leveraging up-to-date source data from the internal/external data sources 105, 110 with the ability to generate the supplier score concurrent with a sourcing request and/or in real-time.

A configuration module 175 may be communicatively coupled to the risk score server 145 and allow the buyer and/or user and/or administrator of the procurement system 100 to configure the calculation scheme or risk score structure of the supplier risk score for the one or more suppliers. The configuration module 175 serves as an interface for the user to tailor the risk score calculation to specific user needs without requiring the user to write software code (SQL queries).

As will be described below and as illustrated in FIG. 3, the supplier risk score may comprise various aspects such as, for example, supplier inherent risk, operational risk, and contractual risk. Each of the aspects may include one or more risk elements 305 having associated risk scores 330 stemming from respective ones of the KPIs 310. The user or administrator of the procurement system 100 may interface with the configuration module 175 to select particular ones of the KPIs 310 the risk score server 145 would leverage when calculating the risk scores for the one or more risk elements comprising the overall supplier risk score.

The procurement workflow widget 150 may be configured to alter a procurement workflow with a customized procurement workflow based on the supplier risk score output of the risk score server 145. Alternatively and/or additionally, the procurement workflow widget 150 may serve as an alert system to the user and/or administrator of changes in risk levels associated with suppliers and by extension a sourcing request risk. As the particular supplier risk score is updated responsive to new updated source data, the procurement workflow may also be revised. As an example, the procurement workflow may include a set of predictable and repetitive tasks in a procure-to-pay process. This workflow handles the responsibility of moving data and documents involved in a procurement function from one step to the next. Each workflow in procurement management may have its own set of approval rules, task assignments, supplier lists, etc.

In particular, the procurement workflow widget 150 may be triggered to initiate a procurement alert and/or procurement workflow customization based on a value of the supplier risk score. For example, if the supplier risk score is above a defined threshold the associated supplier may be deemed a “high-risk” supplier, while suppliers that have an associated supplier risk score below a defined threshold may be deemed “low-risk” supplier. In some embodiments, responsive to a “high-risk” supplier score, the procurement workflow widget 150 may, for example, transmit an alert for display on the procurement system 100 user interface, block the “high-risk” supplier from being selected within the procurement workflow, block the transmission of new PO to the “high-risk” supplier, initiate an improvement plan, and/or initiate a mitigation plan. It will be appreciated that these procurement workflow customizations are mere examples and other types of customizations are contemplated by the disclosure.

In some embodiments, the generated alert includes a listing of high-risk suppliers from the one or more suppliers having the calculated risk scores exceeding the defined risk threshold. In other embodiments, the mitigation plan comprises automatically replacing the high-risk suppliers on a sourcing request with low-risk suppliers such that the list of available suppliers to fulfill a procurement request is limited to the low-risk suppliers. In other embodiments, if the geopolitical risk associated with the supplier's particular facility is high, the procurement workflow widget 150 may provide options of low-risk facilities the supplier may leverage. Alternatively and/or additionally, the procurement workflow widget 150 may automatically update the procurement workflow with selection of a low-risk facility of that particular supplier. Another example of customization comprises updating a preference level associated with the one or more suppliers. Updating the preference level includes configuring an ordered list of the one or more suppliers available to the user (e.g., buyer) based on the preference level associated with the one or more suppliers. Furthermore, implementing the improvement plan comprises alerting the particular supplier of at least one of an alternative shipping mechanism, alternative packing facility, etc. to fulfill a purchase order. It will be appreciated by those of ordinary skill in the art that other embodiments of mitigating procurement risk are contemplated by this disclosure.

FIG. 3 shows a schematic illustration of various aspects of the supplier risk score broken down by risk elements 305, according to one illustrated embodiment. As mentioned above, the supplier risk score may comprise particular combinations of at least one of the risk values 205 stored in the multidimensional database 130, the source data (e.g., operational data) stored in the relational database 125, and/or data stemming from the questionnaire assessment and stored in the relational database 125. In particular, the supplier risk score may leverage data calculated based on a KPI (e.g., Platform Business Intelligence KPI) 310, third party data 315 from the external data source 110, internal data (e.g. operational data) 320 from the internal data source 105, and/or data stemming from the questionnaire assessment responses 325.

The supplier risk score may comprise various aspects such as, for example, supplier inherent risk, operational risk, and contractual risk. Each of the aspects may include the one or more risk elements 305 having associated risk element scores 330. As illustrated in the FIG. 3 block diagram of the supplier risk score configuration, the risk element scores 330 associated with each of the risk elements 305 may be calculated based on a particular one of the KPIs 310, third party data 315, the internal data 320, and/or questionnaire assessment responses 325. Each of the KPIs 310 may amount to various mathematical and/or statistical calculations of the risk values 205 stored in the multidimensional databases 130, the source data (e.g., operational data) stored in the relational database 125, and/or data stemming from the questionnaire assessment and stored in the relational database 125. Some example mathematical and/or statistical operations include: sum, count, average, weighted average, count of elements above a threshold, standard deviation. For purposes of illustration, example KPIs 310 calculated by the risk score server 145 may comprise: payroll risk based on the number of early payment requested, supplier dependence based on spend/revenue ratio, number of late deliveries (OTD), and number of disputes open per month to name a few. Once the KPIs are calculated the risk score server 145 (or any other component associated with the risk score module 135) may convert the KPIs to scores based on a defined set of rules. Additionally and/or alternatively, the third party data 315 from the external data source 110, internal data (e.g. operational data) 320 from the internal data source 105, and/or data stemming from the questionnaire assessment responses 325 that are configured to be associated with particular ones of the risk elements 305 may be converted to scores 330 based on the defined set of rules. The defined set of rules may be configured by the user (e.g., buyer) and/or the administrator of the risk score module 135. In another embodiment, each of the risk elements 305 may have associated risk scores 330 that are determined based on a defined set of rules applied to the combination of the KPIs 310, the third party data 315 from the external data source 110, the internal data (e.g. operational data) 320 from the internal data source 105, and/or data stemming from the questionnaire assessment responses 325 that are configured to be associated with the particular ones of the risk elements 305.

Ultimately, the risk element scores 330 may be combined to form the supplier risk score. The combination of the risk element scores 330 may take any number of forms, for example, average, sum, median, or the like. As illustrated in FIG. 3, the elements 305 may comprise: Financial Risk, Geopolitical Risk, Compliance Risk, Security Risk, Strategic Risk, Supply risk, Quality Risk, and Contractual Risk to name a few. The risk elements 305 may be arranged or associated with the respective aspects of the global risk score (e.g., supplier inherent risk, operational risk, contractual risk). In some embodiments, both the overall supplier risk score is calculated together with a breakdown of the risk element scores 330.

For purposes of illustration, some examples of the third party data 315 leveraged for calculation of one of the risk element scores 330 include: credit risk, government compliance risk (OFAC integration), security risk level, etc. Some examples of the internal data 320 leveraged for calculation of one of the risk element scores 330 include: country risk score, corporate compliance risk based on supplier documents (e.g., ISO 9001 certificate), number of late deliveries, number of returns, pricing adjustments, etc. Some examples of the questionnaire assessment responses 325 leveraged for calculation of one of the risk element scores 330 include: responses related to information security, use rating of supplier performance, responses related to scoring supplier contracts, supplier responsiveness, supplier level of customer service, etc.

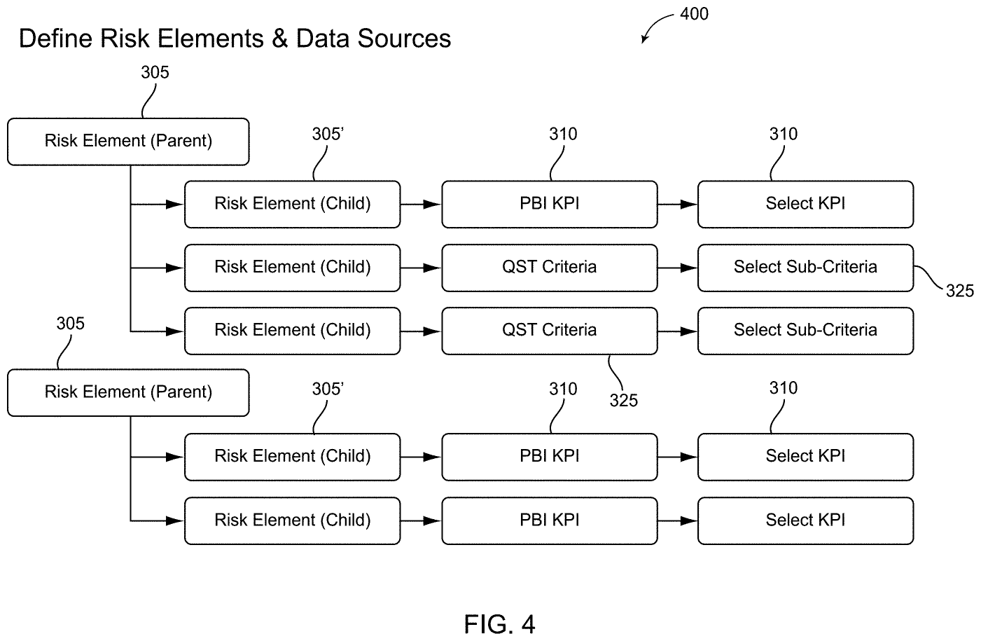

FIG. 4 shows a workflow rendering of the configuration module 175, according to one illustrated embodiment. The configuration module 175 may be communicatively coupled to the risk score server 145 and allow the buyer and/or user and/or administrator of the procurement system 100 to configure the calculation scheme or risk score structure of the supplier risk score for the one or more suppliers. The configuration module 175 serves as an interface for the user to tailor the risk score calculation to specific user needs without requiring the user to write software code (SQL queries). The user or administrator of the procurement system 100 may interface with the configuration module 175 to select particular ones of the KPIs 310 the risk score server 145 would leverage when calculating the risk scores 330 for the one or more risk elements 305 comprising the overall supplier risk score.

Each of the risk elements 305 (“parent” risk elements) may have associated one or more “child” risk elements 305′. The Security Risk element 305 may, for example, comprise a terror risk, credit risk, and/or supplier dependency risk as “child” risk elements 305′. Other examples of “child” risk elements 305′ include risks associated with entities that is part and parcel of the supplier organization. The entities may be a specific site (e.g., country or factory) of the supplier. In other words, the “child” risk element 305′ may be a way to break down the risk element score 330 across dimensions other than time.

Each of the “child” risk elements 305′ may in turn have one or more KPIs 310 as selectable options to include within the calculation scheme for the particular “child” risk element 305′. In some embodiments, the “child” risk element 305′ may have selectable questionnaire assessment criteria 325 that may be included with the calculation scheme for the particular “child” risk element 305′. Additionally, the selectable questionnaire assessment criteria 325 may include one or more selectable sub-criteria. For example, the user may select the particular responses to be used when calculating the particular risk element score 330. Alternatively and/or additionally, the configuration module 175 may advantageously allow the user to select the specific data source from which the selected KPIs 310 extract the underlying data upon which the various mathematical and/or statistical calculations are implemented. In other words, the configuration module 175 allows the user to couple or link the “child” risk element 305′ to a selected data source. The selectable data sources include: source data stored in the relational databases 125 (e.g., operational data stemming from the internal data source 105 (e.g., ERP system)), risk values 205 stored in the multidimensional databases 130 (e.g., OLAP Cube), and/or user-entered data responsive to the questionnaire assessments (QS T/Form).

It will be appreciated that the user/administrator may select the multidimensional databases 130 (e.g., OLAP Cube) when configuring the calculation scheme or risk score structure of the supplier risk score to preserve the real-time experience of generating a supplier risk score (i.e., via OLAP Cube pre-aggregated data in the form of the risk values 205). Alternatively, the user/administrator may select the relational database 125 for risk score calculations that may not require a voluminous amount of data processing (e.g., real-time SQL data processing) across the 2D relational databases. In some embodiments, the configuration module 175 may be set to automatically configure a hybrid calculation scheme where some of the risk element scores 330 are based on source data from the relational databases 125 while other risk element scores 330 are based on source data from the multidimensional databases 130. Various other manifestations of leveraging source data to advantageously leverage real-time processing with up-to-date source data is contemplated by this disclosure.

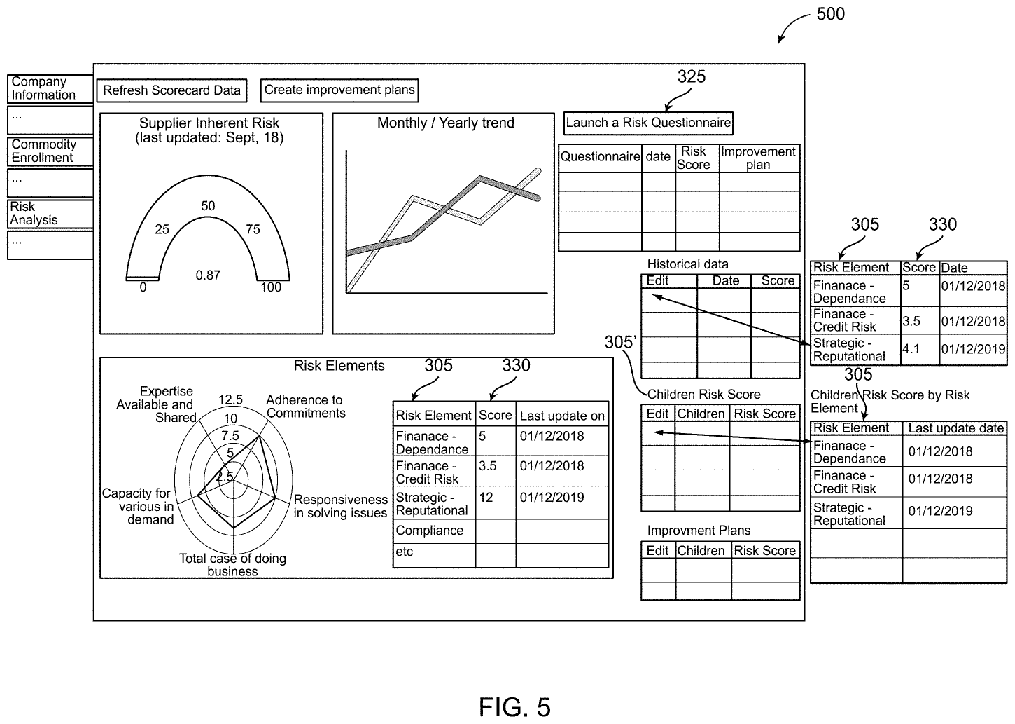

FIG. 5 shows a screenshot mockup of a global supplier risk scoreboard 500, according to one illustrated embodiment. The supplier risk score is displayed via various interactive widgets. The interactive widgets are configured to allow the user to interact with the underlying data in real-time.

The “Supplier Inherent Risk” widget is a visual indicator of the current risk score. In the illustrated example, the current supplier risk score is 0.87 out of 100, where 0 refers to no risk and 100 is high risk. The risk scoreboard 500 may include a “Monthly/Yearly trend” widget that displays a graphical representation of the evolution of the supplier risk score by unit of time (e.g., year, month). The unit of time may be one of the dimensions across which the risk score is calculated. Additionally, a “Risk Elements” widget may provide a graphical representation of the one or more risk elements 305 associated with the overall supplier risk score. In particular, the “Risk Elements” widget may display a granular breakdown of the particular one or more risk element scores 330 along with an indication of when the risk element score 330 was last updated. The “Historical Data” widget may be configured to allow the user to review details of a particular risk element 305 and associated risk element score 330. In particular, the “Historical Data” widget allows for the user to monitor evolution of that risk element score 330 associated with the risk elements 305 over time.

The “Children Risk Score” widget may be configured to display the one or more “child” risk elements 305′ explained above with regard to FIG. 4. Additionally, the element risk scores 330 may be broken down to more granular scores of “child” risk scores as displayed in the “Children Risk Score” widget. Having the “child” risk scores displayed provides more transparency to the user on potential mitigation or improvement plans to further reduce the supplier risk score. For example, the “child” risk elements 305′ associated with a particular risk element 305 may be related to specific locations of the supplier. In other words, the “child” risk elements 305′ may be particular factories or fulfillment centers operated by the supplier in different regions. If a particular factory-region has an associated high risk score, the procurement system 100 and/or the user may mitigate the risk by choosing another factory-region with a lower risk score. It will be appreciated that the mitigation of overall supplier risk score may be implemented automatically by the procurement workflow widget 150 or manually by the user/administrator or a combination thereof.

In one embodiment, the “Improvement Plan” widget provides various options for improving a procurement workflow for suppliers having an associated risk score above a defined acceptable risk threshold. As previously discussed, various workflow options can be triggered when the supplier risk score and/or the risk element score 330 and/or the “child” risk score exceeds the defined acceptable threshold for procurement risk tolerance. It will be appreciated the defined threshold may be set by the user/administrator.

The questionnaire assessment 325 may be launched via the risk scorecard 500. The results of the user-responses to the questionnaire along with associated assessment questions may be tracked and displayed along with an optional procurement improvement work plan.

### Glossary of Terms

Supplier risk score: A score or value associated with a particular supplier in a supply chain that is associated with an amount of risk that the procurement request will not be timely fulfilled per the terms of the purchase order, purchase requisition, or any other contract. The supplier risk score incorporates several risk elements (e.g., strategic, security, compliance, geographic, financial, quality, contractual, etc.) in the overall risk score.

Risk elements: A breakdown of the supplier risk score across specific risk aspects (e.g., strategic, security, compliance, geographic, financial, quality, contractual, etc.). The risk elements are combined to form the global supplier risk score.

Risk value(s): The risk values comprise values resulting from a particular combination of portions of the source data (e.g., operational data) stored in a relational database. For example, some combination may include summing data, averaging data, counting number of times data is above a threshold, etc. There may be several risk values associated with a particular risk element. The risk values for each risk element are analyzed to determine the risk score for that particular risk element. The risk values may, for example, be determined based on aggregation of data by dimensions and/or receipt of answers from questionnaire campaigns. In particular, the risk value may be a result of an aggregate of source data by selected variables from relational databases (e.g., two-dimensional tables), where the variables correspond to defined dimension members of the multidimensional database (e.g., OLAP Cube).

Source Data: Any type of data relevant to determining a risk of procuring goods/services from suppliers. The source data includes internal and external operational data. For example, source data includes information from ERP system, third party sources (credit agency, etc.), CRM systems, questionnaire assessments, or the like.

Aggregate or aggregation: Aggregation is a method of summarizing a group of data items by dimension in order to return a single value for a particular pair of dimension Members. Multidimensional databases (e.g., OLAP Cube) generally have a plurality of dimension Members within a Dimension. Aggregation, as used herein, refers to computing a value summary that is stored in the multidimensional database at the cross-section of two dimension Members from different Dimensions in an OLAP Cube database. For example, in FIG. 2, the risk value of 19 refers to a measure or aggregation of “Sales Quantity” of “Confections” (dimension Member from ‘Product Category’ Dimension) for Supplier A in the month of “April” (dimension Member from ‘Time’ Dimension).

Dimensions are lists of related terms used to organize data. For example, a Dimension name for the Members January, February and March might be “Months.” Dimensions, in turn, are used to construct Cubes, the multidimensional structures in which to store and model data.

Dimension Members are used to identify a data item's position and description within a dimension, and they in turn make up a Dimension. One of the characteristics of a Member name is that it is unique within a database. In FIG. 2, “Product Category” and “Time” are Dimensions, while “Confections, Condiments, Beverages” are Dimension Members of the “Product Category” Dimension. Additionally, “January, February, March, April” are Dimension Members of the “Time” Dimension.

Relational Database: A two-dimensional table of data entries where the table of data entries may be organized in columns and rows. Most relational databases use the same table format for organizing data. Each row, usually called a record, is divided into columns. A database table can have hundreds or even millions of records. Each column is labeled with a name to describe what type of information it is used for. A table containing customer information, for example, would have a row for the first name, last name, street number, street name, city, etc.

Multidimensional database: A database that allows fast analysis of data according to the multiple Dimensions that define a business problem or procurement analysis. For example, a multidimensional cube for reporting sales might comprise several Dimensions, for example, Salesperson, Sales Amount, Region, Product, Region, Month, Year. The arrangement of data into Cubes overcomes a limitation of relational databases, which may not be well suited for near instantaneous analysis and display of large amounts of data. Instead, such relational databases may be better suited for creating records from a series of transactions known as On-Line Transaction Processing (“OLTP”). Although many report-writing tools exist for relational databases, these are slow when the whole database must be summarized, and present great difficulties when users wish to re-orient reports or analyses according to different, multidimensional perspectives (i.e., Slices). The use of Cubes facilitate this kind of fast end-user interaction with data. An OLAP Cube can be thought of as an extension of the modeling structure provided by a spreadsheet, which accommodates data in rows and columns (i.e., a two-dimensional array of data). A Cube can accommodate any number of arrays, or Dimensions.

Key Performance Indicator (“KPI”): KPIs are a result of various mathematical and/or statistical calculations of the risk values stored in the multidimensional databases, the source data (e.g., operational data) stored in the relational database, and/or data stemming from the questionnaire assessment and stored in the relational database. Some example mathematical and/or statistical operations include: sum, count, average, weighted average, count of elements above a threshold, standard deviation, etc.

API or Application Programming Interface is a set of routines, data structures, object classes and/or protocols used by programmers to build applications or communicate between different Applications.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the above descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

What is claimed is:

1. A method for generating a supplier risk score in a procurement system, the method comprising:
storing source data pertaining to one or more suppliers in a relational database of the procurement system according to a plurality of variables;
aggregating portions of the source data by selected ones of the plurality of variables to determine risk values, wherein the aggregating occurs at defined time intervals or responsive to an update of the source data stored in the relational database;
storing the risk values at locations within one or more multidimensional databases having dimension member pairs corresponding to the selected ones of the plurality of variables;
calculating a risk score of the one or more suppliers responsive to at least one of querying the source data stored in the relational database or the risk values stored in the one or more multidimensional databases; and
triggering a procurement workflow based on the calculated risk score of the one or more suppliers.

2. The method of claim 1, wherein triggering the procurement workflow comprises generating an alert via the procurement system, the generated alert includes a listing of high-risk suppliers from the one or more suppliers having the calculated risk scores exceeding a defined risk threshold.

3. The method of claim 2, responsive to a user-generated sourcing request for respective ones of the one or more suppliers, displaying low-risk suppliers to replace high-risk suppliers on the sourcing request, wherein the low-risk suppliers have calculated risk scores below the defined risk threshold.

4. The method of claim 1, wherein triggering the procurement workflow comprises updating a preference level associated with of the one or more suppliers.

5. The method of claim 4, wherein updating the preference level includes configuring an ordered list of the one or more suppliers available to a buyer based on the preference level associated with the one or more suppliers.

6. The method of claim 1, wherein aggregating portions of the source data by selected ones of the plurality of variables to determine the risk values occurs responsive to receiving updated source data by the procurement system.

7. The method of claim 1, wherein querying the source data stored in the relational database or the risk values stored in the multidimensional database occurs responsive to receiving a selection of at least one of the relational database or the multidimensional database from a user.

8. The method of claim 1, wherein querying the source data stored in the relational database results in a real-time calculation of the risk values.

9. The method of claim 1, further comprising implementing an improvement plan for a particular supplier having an associated risk score below a defined threshold.

10. The method of claim 9, wherein implementing the improvement plan comprises alerting the particular supplier of at least one of an alternative shipping mechanism, packing facility, etc. to fulfill a purchase order.

11. The method of claim 1, wherein storing the source data includes storing operational data received from at least one of an internal Enterprise Resource Planning (ERP) system of the procurement system or user-entered source data via a questionnaire.

12. The method of claim 1, wherein storing the source data further includes storing third party data received via an API.

13. A non-transitory computer readable medium having a memory and instructions stored therein that when executed by a processor performs a method comprising:
storing source data pertaining to one or more suppliers in a relational database of the procurement system according to a plurality of variables;
aggregating portions of the source data by selected ones of the plurality of variables to determine risk values, wherein the aggregating occurs at defined time intervals or responsive to an update of the source data stored in the relational database;
storing the risk values at locations within one or more multidimensional databases having dimension member pairs corresponding to the selected ones of the plurality of variables;
calculating a risk score of the one or more suppliers responsive to at least one of querying the source data stored in the relational database or the risk values stored in the one or more multidimensional databases; and
triggering a procurement workflow based on the calculated risk score of the one or more suppliers.

14. The non-transitory computer readable medium of claim 13, wherein triggering the procurement workflow comprises generating an alert via the procurement system, the generated alert includes a listing of high-risk suppliers from the one or more suppliers having the calculated risk scores exceeding a defined risk threshold.

15. The non-transitory computer readable medium of claim 14, wherein responsive to a user-generated sourcing request for respective ones of the one or more suppliers displaying low-risk suppliers to replace high-risk suppliers on the sourcing request, wherein the low-risk suppliers have calculated risk scores below the defined risk threshold.

16. The non-transitory computer readable medium of claim 13, wherein triggering the procurement workflow comprises updating a preference level associated with of the one or more suppliers.

17. The non-transitory computer readable medium of claim 16, wherein updating the preference level includes configuring an ordered list of the one or more suppliers available to a buyer based on the preference level associated with the one or more suppliers.

18. The non-transitory computer readable medium of claim 13, wherein aggregating portions of the source data by selected ones of the plurality of variables to determine the risk values occurs responsive to receiving updated source data by the procurement system.

19. The non-transitory computer readable medium of claim 13, wherein querying the source data stored in the relational database or the risk values stored in the multidimensional database occurs responsive to receiving a selection of at least one of the relational database or the multidimensional database from a user.

20. The non-transitory computer readable medium of claim 13, wherein querying the source data stored in the relational database results in a real-time calculation of the risk values.
